(19) United States
(12) Patent Application Publication
(10) Pub. No.: US 2012/0255033 A1
(43) Pub. Date: Oct. 4, 2012

(54) LICENSING SOFTWARE ON A SINGLE-USER BASIS

(75) Inventors: Sanjeev Dwivedi, Sammamish, WA (US); Sunil S. Kadam, Redmond, WA (US); Ziquan Li, Redmond, WA (US); Alwin Vyhmeister, Seattle, WA (US); Ariye M. Cohen, Bellevue, WA (US); Varun Eda Naarayana Kulothungan, Bellevue, WA (US); Saurabh Boyed, Bothell, WA (US); Aravind Aluri, Bellevue, WA (US)

(73) Assignee: Microsoft Corporation, Redmond, WA (US)

(21) Appl. No.: 13/072,784

(22) Filed: Mar. 28, 2011

(51) Int. Cl. G06F 21/22

(52) U.S. Cl. 726/28

(57) ABSTRACT

The claimed subject matter provides a method for licensing software in a computing environment. An exemplary method includes initiating application software program on a computer system having a plurality of authorized users, one of the authorized users having a single-user license to use the software program. An identity of a current user of the computer system is checked. Operation of the software program is prohibited if the current user is one of the plurality of authorized users other than the user who is granted the single-user license.

### BACKGROUND

When purchasing software, a user typically obtains license rights to the software. Such license rights may apply to the use of the software on a particular computer system. This means that any user who is authorized to use the computer on which the software is installed is able to use the software.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject relates to a method for licensing software in a computing environment. An exemplary method includes initiating a software program on a computer system having a plurality of authorized users in response to the request of an authorized user who holds a single-user license to the software program. An identity of a current user of the computer system is checked. Operation of the software program is prohibited if the current user is one of the plurality of authorized users of the computer system other than the user who is granted the single-user license.

One embodiment of the claimed subject matter relates to a computer system for licensing software. The computer system comprises a processing unit and a system memory. The computer system has a plurality of authorized users, one of whom holds a single-user license to a software program on the computer system. The system memory stores code configured to direct the processing unit to receive the software program and licensing information indicating that a license type of the software program is a single-user license, along with licensing information identifying a user who is granted the single-user license. The system memory also comprises code that directs the processing unit to check an identity of a current user of the computer system. Other code stored in the system memory directs the processing unit to prohibit operation of the software program if the current user is one of the plurality of authorized users other than the user who is granted the single-user license.

Another embodiment relates to one or more computer-readable storage media that store software licensing code. The software licensing code is configured to direct a processing unit to receive an application program and licensing information indicating that a license type of the application program is a single-user license, along with licensing information identifying a user who is granted the single-user license. Additional code causes the processing unit to initiate the application program on a computer system having a plurality of authorized users, one of the plurality of users being the user who is granted the single-user license. Other code directs the processing unit to prohibit operation of the application program if the current user is one of the plurality of authorized users other than the user who is granted the single-user license.

### BRIEF DESCRIPTION OF THE DRAWINGS

FIG. 1 is a block diagram of a system in which a method of licensing software according to the subject innovation may be performed;

FIG. 2 is a process flow diagram of a method of licensing software according to the subject innovation;

FIG. 3 is a block diagram of an exemplary networking environment wherein aspects of the claimed subject matter can be employed; and

FIG. 4 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The subject innovation provides that a license to use software may be granted to an individual user of a computer system, as opposed to all users of the computer system. In this manner, use of the software may be restricted to a specific user. In an example embodiment, a licensed software application queries a license information storage area for a license type or status. If the license type or status returned as a result of the query indicates that the software is licensed to an individual user, the software will be operative only if the licensed user is the current user.

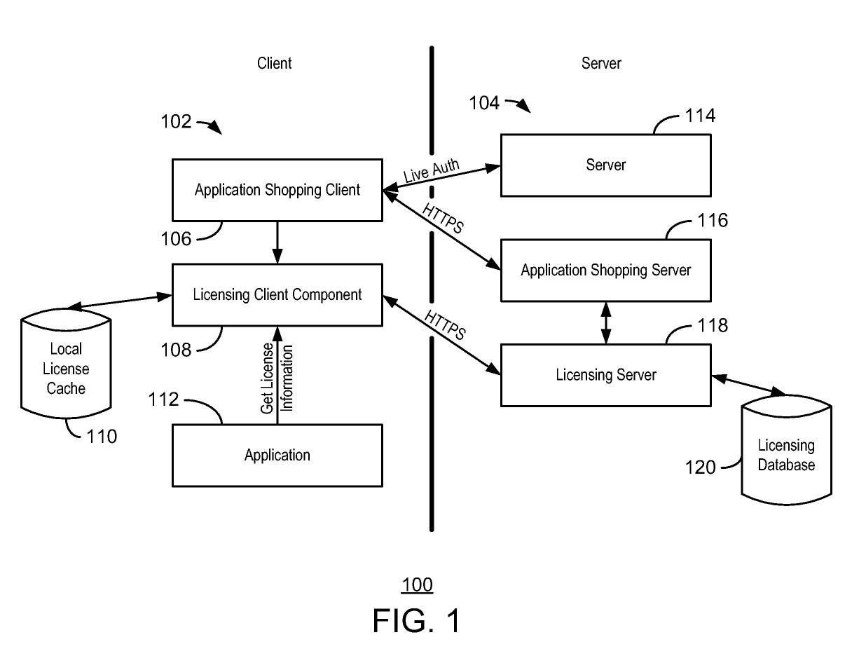

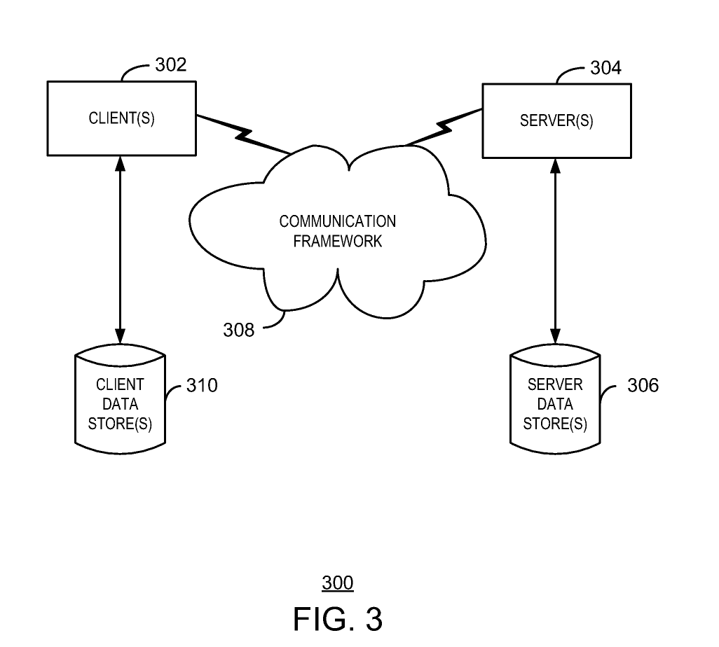

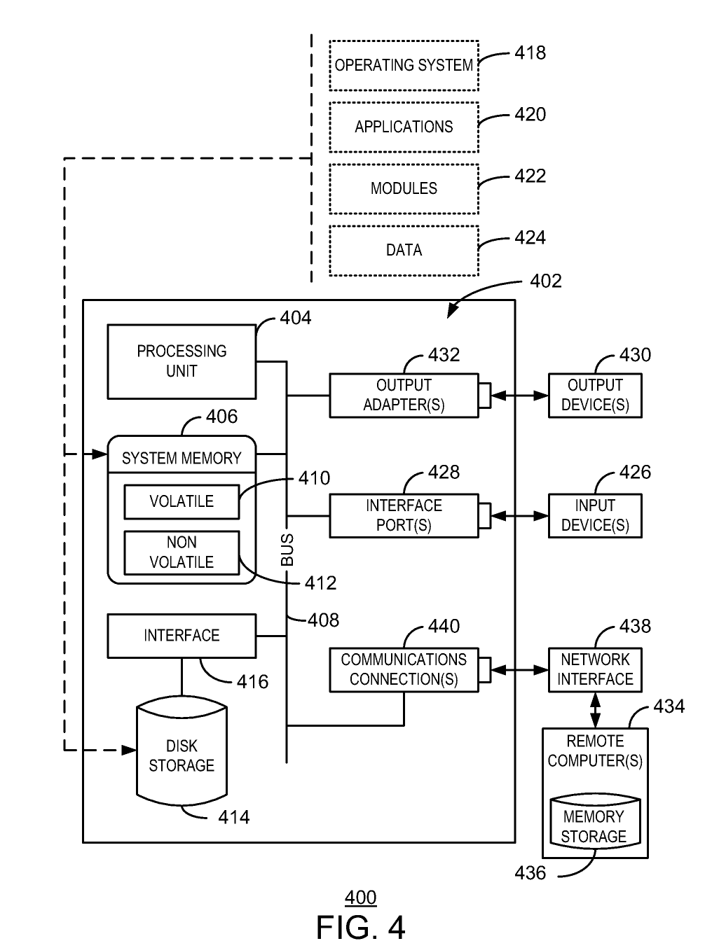

FIG. 1 is a block diagram of a system 100 in which software licensing according to the subject innovation may be practiced. The system 100 includes a client environment 102 depicted in a left panel of FIG. 1. As explained herein with reference to FIGS. 3 and 4, the client environment 102 may be implemented in a client computing system. A right panel of FIG. 1 depicts a server environment 104, such as a server computing system. The server environment 104 represented in the right panel may be disposed, for example, in a server computing system in a cloud computing environment. Moreover, the server environment 104 may be connected to a network such as the Internet.

The client environment 102 comprises an application shopping client 106. An example of an application shopping client 106 in a Windows® computing environment is a Windows® Store client. In an example embodiment, the application shopping client 106 may be implemented as a component or module of an operating system. The application shopping client 106 communicates with an authentication server and an application shopping server, as explained herein.

A licensing client component 108 is also included in the client environment 102. The licensing client component 108 maintains licensing information in a local license cache 110 of the client environment 102. The licensing client component 108 may receive licensing information from a licensing server, as explained herein.

An application program 112 may be executed in the client environment 102. The application program 112 may obtain license information from the local license cache 110 via the licensing client component 108. The license information obtained from the local license cache 110 may govern aspects of the operation of the application program 112.

The server environment 104 includes a server 114 that, among other things, provides authentication when a user of the client environment 102 logs in. The user of the client environment 102 may have an account on the server 114, and may log in for the purpose of buying a software application. The user may provide a login credential such as an on-line ID as part of the logging on to the server 114. One example of the server 114 in a Windows® computing environment is a Windows Live® server.

The server environment 104 includes an application shopping server 116 that may provide the user of the client environment 102 with a selection of software applications available for purchase. After being authenticated by the server 114, the application shopping client 106 may engage in a secure connection with the application shopping server 116. One example of the application shopping server 116 in a Windows® computing environment is a Windows® Store server.

The application shopping server 116 may have access to a licensing server 118. One example of the licensing server 118 in a Windows® computing environment is a Windows® Store licensing server. The licensing server 118 may in turn access license information stored in a licensing database 120. The licensing database 120 may provide a licensing credential having embedded licensing information such as a license type (for example, a license type could be single-user license) when a user obtains a software application from the application shopping server 116. The licensing information may further include user identification information to identify the single user who is authorized to use the application program. The user identification information may include an on-line ID such as a Windows Live® Passport Unique ID (PUID). In addition, licensing information may include an expiration date (if applicable) or an application ID, which may be used to identify the application program. The licensing server 118 may engage in a secure connection with the licensing client component 108 to provide the user of the client environment 102 with the licensing information.

According to the subject innovation, an application program having a single-user license type may be acquired from the application shopping server 116. Licensing information indicating the single-user license status is obtained from the licensing database 120 via the licensing server 118 and provided to the user. The licensing information may also specify the identity of the user who is authorized to use the application program. This information may comprise a login credential used by the user to access the server 114. In an example embodiment, the licensing information is provided via a secure connection between the licensing server 118 and the licensing client component 108. After being received by the licensing client component 108, the license information is stored in the local license cache 110. For example, when an application program is obtained with a single-user license, a single-user license type is recorded in the local license cache 110.

In one embodiment, each time the application program 112 is initiated in the client environment 102, the application program 112 queries the local license cache 110 for the licensing status of the application program 112. This query may take the form of a call from the application program 112 to the licensing client component 108. If the application program was obtained with a single-user license, a single-user licensing status will be returned when the local license cache 110 is queried by the application program 112. According to the subject innovation, the application program 112 only executes if the identity of the user contained in the license information stored in the local license cache 110 corresponds to the user currently logged on to the client environment 102. This is true even though there may be other authorized users of the client environment 102.

A user may be permitted to register the software application for use under a single-user license with more than one machine. This registration may be performed via the user's account on the server 114. In this event, the licensing information provided by the licensing server 118 may include information that identifies each of the registered machines of the user.

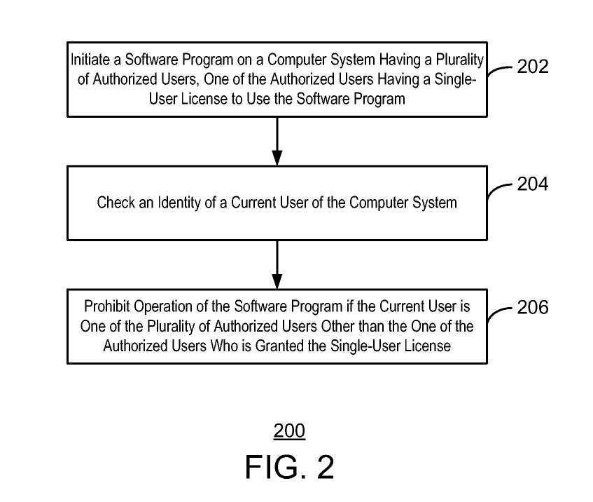

FIG. 2 is a process flow diagram of a method 200 of licensing software in a computing environment according to the subject innovation. In an example embodiment, a software program may be received by a user of a computer system in the client environment 102. Along with the software program, licensing information that indicates that a license type of the software program is a single-user license may be received. Additional licensing information may be received that identifies a user who is granted the single-user license. In one embodiment, the software program is obtained by the user from an application shopping server 116 via a user account on the application shopping server 116.

At block 202, the software program is initiated on a computer system having a plurality of authorized users. Among the authorized users of the computer system is the single-user licensee of the software program. At block 204, the software program checks the identity of a current user of the computer system. If the current user is not the single-user licensee of the software program, operation of the software program is prohibited, as shown at block 206. This prohibition is enforced even though the current user may be an authorized user of the computer system. In this manner, per user licensing of the software program may be enforced.

FIG. 3 is a block diagram of an exemplary networking environment 300 wherein aspects of the claimed subject matter can be employed. Moreover, the exemplary networking environment 300 may be used to implement a system and method of licensing software according to the subject innovation.

The networking environment 300 includes one or more client(s) 302. The client(s) 302 can be hardware and/or software (e.g., threads, processes, computing devices). As an example, the client(s) 302 may be computers providing access to servers over a communication framework 308, such as the Internet. The client(s) 302 may correspond to the client environment 102 shown and described herein with reference to FIG. 1.

The environment 300 also includes one or more server(s) 304. The server(s) 304 can be hardware and/or software (e.g., threads, processes, computing devices). The server(s) 304 may include network storage systems. The server(s) may be accessed by the client(s) 302. As described herein, the server(s) 304 may correspond to the server environment 104 shown and described herein with reference to FIG. 1.

One possible communication between a client 302 and a server 304 can be in the form of a data packet adapted to be transmitted between two or more computer processes. The environment 300 includes a communication framework 308 that can be employed to facilitate communications between the client(s) 302 and the server(s) 304.

The client(s) 302 are operably connected to one or more client data store(s) 310 that can be employed to store information local to the client(s) 302. The client data store(s) 310 may be located in the client(s) 302, or remotely, such as in a cloud server. One example of the client data store(s) 310 includes the local license cache 110 shown and described in FIG. 1. Similarly, the server(s) 304 are operably connected to one or more server data store(s) 306 that can be employed to store information local to the servers 304. An example of the server data store(s) 306 includes the licensing database 120 shown and described in FIG. 1.

With reference to FIG. 4, an exemplary operating environment 400 is shown for implementing various aspects of the claimed subject matter. The exemplary operating environment 400 includes a computer 402. The computer 402 includes a processing unit 404, a system memory 406, and a system bus 408. The computer 402 may form a portion of either the client environment 102 or the server environment 104.

The system bus 408 couples system components including, but not limited to, the system memory 406 to the processing unit 404. The processing unit 404 can be any of various available processors. Dual microprocessors and other multiprocessor architectures also can be employed as the processing unit 404.

The system bus 408 can be any of several types of bus structure(s) including the memory bus or memory controller, a peripheral bus or external bus, and/or a local bus using any variety of available bus architectures known to those of ordinary skill in the art. The system memory 406 comprises non-transitory computer-readable storage media that includes volatile memory 410 and non-volatile memory 412.

The basic input/output system (BIOS), containing the basic routines to transfer information between elements within the computer 402, such as during start-up, is stored in non-volatile memory 412. By way of illustration, and not limitation, non-volatile memory 412 can include read only memory (ROM), programmable ROM (PROM), electrically programmable ROM (EPROM), electrically erasable programmable ROM (EEPROM), or flash memory.

Volatile memory 410 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 402 also includes other non-transitory computer-readable media, such as removable/non-removable, volatile/non-volatile computer storage media. FIG. 4 shows, for example a disk storage 414. Disk storage 414 includes, but is not limited to, devices like a magnetic disk drive, floppy disk drive, tape drive, Jaz drive, Zip drive, LS-100 drive, flash memory card, or memory stick.

In addition, disk storage 414 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 414 to the system bus 408, a removable or non-removable interface is typically used such as interface 416.

It is to be appreciated that FIG. 4 describes software that acts as an intermediary between users and the basic computer resources described in the suitable operating environment 400. Such software includes an operating system 418. Operating system 418, which can be stored on disk storage 414, acts to control and allocate resources of the computer 402.

System applications 420 take advantage of the management of resources by operating system 418 through program modules 422 and program data 424 stored either in system memory 406 or on disk storage 414. It is to be appreciated that the claimed subject matter can be implemented with various operating systems or combinations of operating systems.

A user enters commands or information into the computer 402 through input device(s) 426. Input devices 426 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 426 connect to the processing unit 404 through the system bus 408 via interface port(s) 428. Interface port(s) 428 include, for example, a serial port, a parallel port, a game port, and a universal serial bus (USB).

Output device(s) 430 use some of the same type of ports as input device(s) 426. Thus, for example, a USB port may be used to provide input to the computer 402, and to output information from computer 402 to an output device 430.

Output adapter 432 is provided to illustrate that there are some output devices 430 like monitors, speakers, and printers, among other output devices 430, which are accessible via adapters. The output adapters 432 include, by way of illustration and not limitation, video and sound cards that provide a means of connection between the output device 430 and the system bus 408. It can be noted that other devices and/or systems of devices provide both input and output capabilities such as remote computer(s) 434.

The computer 402 can be a server hosting various software applications in a networked environment using logical connections to one or more remote computers, such as remote computer(s) 434. The remote computer(s) 434 may be client systems configured with web browsers, PC applications, mobile phone applications, and the like.

The remote computer(s) 434 can be a personal computer, a server, a router, a network PC, a workstation, a microprocessor based appliance, a mobile phone, a peer device or other common network node and the like, and typically includes many or all of the elements described relative to the computer 402.

For purposes of brevity, only a memory storage device 436 is illustrated with remote computer(s) 434. Remote computer(s) 434 is logically connected to the computer 402 through a network interface 438 and then physically connected via a communication connection 440.

Network interface 438 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 440 refers to the hardware/software employed to connect the network interface 438 to the bus 408. While communication connection 440 is shown for illustrative clarity inside computer 402, it can also be external to the computer 402. The hardware/software for connection to the network interface 438 may include, for exemplary purposes only, internal and external technologies such as, mobile phone switches, modems including regular telephone grade modems, cable modems and DSL modems, ISDN adapters, and Ethernet cards.

An exemplary processing unit 404 for the server may be a computing cluster comprising Intel® Xeon CPUs. The disk storage 414 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for licensing software, comprising:
initiating a software program on a computer system having a plurality of authorized users, one of the authorized users having a single-user license to use the software program;
checking an identity of a current user of the computer system; and
prohibiting operation of the software program if the current user is one of the plurality of authorized users other than the one of the authorized users who is granted the single-user license.

2. The method recited in claim 1, comprising:
sending a login credential along with a request to obtain the software program; and
receiving the software program and licensing information indicating that a license type of the software program is a single-user license, along with licensing information identifying the one of the authorized users who is granted the single-user license.

3. The method recited in claim 2, wherein the login credential comprises a Windows Live® Passport Unique ID (PUID).

4. The method recited in claim 1, comprising storing licensing information indicating that the license status of the software program is a single-user license, along with licensing information identifying the one of the authorized users who is granted the single-user license in a local licensing cache of the computer system.

5. The method recited in claim 1, comprising receiving licensing information indicating an expiration date of the single-user license to use the software program.

6. The method recited in claim 1, comprising receiving licensing information indicating an application ID that identifies the software program.

7. The method recited in claim 1, comprising placing a call to a licensing client component to retrieve licensing information indicating that a license type of the software program is a single-user license, along with the licensing information identifying the one of the authorized users who is granted the single-user license.

8. A system for licensing software, comprising:
a processing unit; and
a system memory, wherein the system memory comprises code configured to direct the processing unit to:
receive a software program and licensing information indicating that a license type of the software program is a single-user license, along with licensing information identifying a user who is granted the single-user license;
check an identity of a current user of a computer system having a plurality of authorized users when the software program is initiated, one of the plurality of authorized users being the user who is granted the single-user license; and
prohibit operation of the software program if the current user is one of the plurality of authorized users other than the user who is granted the single-user license.

9. The system recited in claim 8, wherein the memory comprises code configured to direct the processing unit to send a login credential prior to receiving the software program, wherein the login credential comprises at least a portion of the licensing information identifying the user who is granted the single-user license.

10. The system recited in claim 9, wherein the login credential comprises a Windows Live® Passport Unique ID (PUID).

11. The system recited in claim 8, comprising a local licensing cache that stores the licensing information indicating that the license status of the software program is a single-user license, along with licensing information identifying the user who is granted the single-user license.

12. The system recited in claim 8, wherein the memory comprises code configured to direct the processing unit to receive licensing information indicating an expiration date of a license to use the software program.

13. The system recited in claim 8, wherein the memory comprises code configured to direct the processing unit to receive licensing information indicating an application ID that identifies the software program.

14. The system recited in claim 8, wherein the memory comprises code configured to direct the processing unit to place a call to a licensing client component to retrieve the licensing information indicating that a license type of the software program is a single-user license, along with the licensing information identifying a user who is granted the single-user license.

15. One or more computer-readable storage media, comprising software licensing code configured to direct a processing unit to:
receive an application program and licensing information indicating that a license type of the application program is a single-user license, along with licensing information identifying a user who is granted the single-user license;
initiate the application program on a computer system having a plurality of authorized users, one of the plurality of users being the user who is granted the single-user license; and
prohibit operation of the application program if the current user is one of the plurality of authorized users other than the user who is granted the single-user license.

16. The one or more computer-readable storage media recited in claim 15, comprising code configured to direct the processing unit to send a login credential prior to receiving the application program, wherein the login credential comprises at least a portion of the licensing information identifying the user who is granted the single-user license.

17. The one or more computer-readable storage media recited in claim 15, wherein the login credential comprises a Windows Live® Passport Unique ID (PUID).

18. The one or more computer-readable storage media recited in claim 15, comprising a local licensing cache that stores the licensing information indicating that the license status of the application program is a single-user license, along with licensing information identifying the user who is granted the single-user license.

19. The one or more computer-readable storage media recited in claim 15, comprising code configured to direct the processing unit to receive licensing information indicating an expiration date of a license to use the application program.

20. The one or more computer-readable storage media recited in claim 15, comprising code configured to direct the processing unit to place a call to a licensing client component to retrieve the licensing information indicating that a license type of the application program is a single-user license, along with the licensing information identifying a user who is granted the single-user license.
